(19) United States
(12) Patent Application Publication
(10) Pub. No.: US 2006/0133376 A1
(43) Pub. Date: Jun. 22, 2006

(54) Multicast transmission protocol for fabric services

(75) Inventor: Ezio Valdevit, Redwood City, CA (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: Brocade Communications Systems, Inc.

(21) Appl. No.: 11/020,892

(22) Filed: Dec. 22, 2004

(51) Int. Cl. H04L 12/56; H04J 3/26

(52) U.S. Cl. 370/390; 370/432

(57) ABSTRACT

The use of multicast transmission for all the data that has to be sent directly from one switch to every switch in the fabric, such as Fabric Service commands. This does not include data flooded through the fabric (as opposed to being sent to each switch individually) like ELPs or FSPF updates. With multicast transmission, a switch needs to execute only one transmission operation to send the same copy of a message to all other switches. Only one copy needs to be queued, and only one copy at the most traverses an ISL in the fabric.

### BACKGROUND OF THE INVENTION

1. Field of the Invention

The invention generally relates to storage area networking, and more particularly to interswitch operations in a storage area network.

2. Description of the Related Art

Storage Area Networks (SANs) have developed to allow better utilization of high performance storage capacity. Multiple servers can access multiple storage devices, all independently and at very high data transfer rates. A primary way SANs are developed is by developing a fabric of Fibre Channel switches. The Fibre Channel protocol is good at performing large block transfers at very high rates and very reliably. By using a series of switches, a switching fabric is developed to allow improved fault tolerance and improved throughput.

The interactions of the Fibre Channel switches are defined in ANSI Standard FC-SW-2, for one. These interactions fall under a general category of fabric services. Most fabric services often need to send the same data to all switches in the fabric. For example, a zoning configuration change made on a switch must be propagated to all switches. Another example is an RSCN (Registered State Change Notification). Another example is a DRLIR (Distributed Registered Link Incident Report). Today this is done by transmitting a copy of the same data to all the other switches in the fabric, one switch at the time. In a fabric with N switches, this involves at least N transmission operations on each switch. Typically these transmissions are initiated by a daemon in user space, and therefore use many switch CPU cycles to activate the kernel driver and to transfer data from user to kernel space. Usually data to be transmitted is stored in some queue or buffer (or both). It waits in the queue until some information is received, whether it is an ACK or a higher level acknowledgement. If the data to be transmitted is large, as a zoning database may be, a large amount of memory may be tied up for a while.

Lastly, as N copies of the same data have to be transmitted, the bandwidth usage is relatively high. This is not a big problem per se: after all, even large zone databases, such as 500 kB, do not use a lot of bandwidth on a multi-Gb/s link. If this has to be transmitted 100 times in a 100 switch fabric, it would still take only a few hundreds of milliseconds of transmission time. However, all those frames have to be received and processed by the target switches, and the processing takes a lot more switch CPU cycles than the raw transmission. In addition, switches may have to implement a throttling mechanism on input frames to prevent CPU overload. The consequence then might be that the input buffers would fill up, and the switch would stop returning buffer to buffer credit. This would act as a back pressure signal and propagate all the way back to the sender, which potentially would not even be able to send frames queued up for an idle switch because of lack of credit on the local outgoing ISL. If the queue were backed up long enough, some exchanges might time out before the frames were even transmitted. The frames would be transmitted anyway, but they would be rejected by the receiver and would eventually be retransmitted. Depending on the conditions, this situation might create a positive feedback that causes the protocol to never converge.

The number of transmissions required by a single switch, and all the associated problems, grow linearly and the total number of transmissions in the whole fabric grows exponentially. This poses a limitation on the ability of a fabric to scale.

Therefore a technique to reduce the switch CPU consumption and otherwise improve fabric scalability for these fabric services events would be desireable.

### SUMMARY OF THE INVENTION

This specification defines and describes the use of multicast transmission for all the data that has to be sent directly from one switch to every switch in the fabric. This does not include data flooded through the fabric (as opposed to being sent to each switch individually) like ELPs or FSPF updates. With multicast transmission, a switch needs to execute only one transmission operation to send the same copy of a message to all other switches. Only one copy needs to be queued, and only one copy at the most traverses an ISL in the fabric. The advantages of this approach are:

1) Less transmission operations, leading to a large reduction in switch CPU cycles.

2) Fewer copies of the same data in the various output buffers, leading to a significant reduction in memory usage.

3) Reduced bandwidth usage for control data, and consequent reduction of the port throttling effects.

4) Faster protocol convergence, due to a single transmission from the source, with no wait.

5) Scalability independent from the number of switches in the fabric for those protocols that require direct transmission of data to all switches in the fabric.

### BRIEF DESCRIPTION OF THE DRAWINGS

FIG. 1 is a general view of a storage area network (SAN);

FIG. 2 is a block diagram of an exemplary switch according to the present invention.

FIG. 3 is an illustration of the software modules in a switch according to the present invention.

FIG. 4 is an illustration of buffer allocation when sending data to each switch according to the prior art.

FIG. 5 is an illustration of buffer allocation when sending data to each switch according to the present invention.

FIG. 6A is a flowchart for a transmitting switch sending data to each switch according to the prior art.

FIG. 6B is a flowchart for a transmitting switch receiving replies to the data transmitted in FIG. 6A according to the prior art.

FIG. 7A is a flowchart for a transmitting switch sending data to each switch according to the present invention.

FIG. 7B is a flowchart for a transmitting switch receiving replies to the data transmitted in FIG. 7A according to the present invention.

### DETAILED DESCRIPTION OF THE PREFERRED EMBODIMENTS

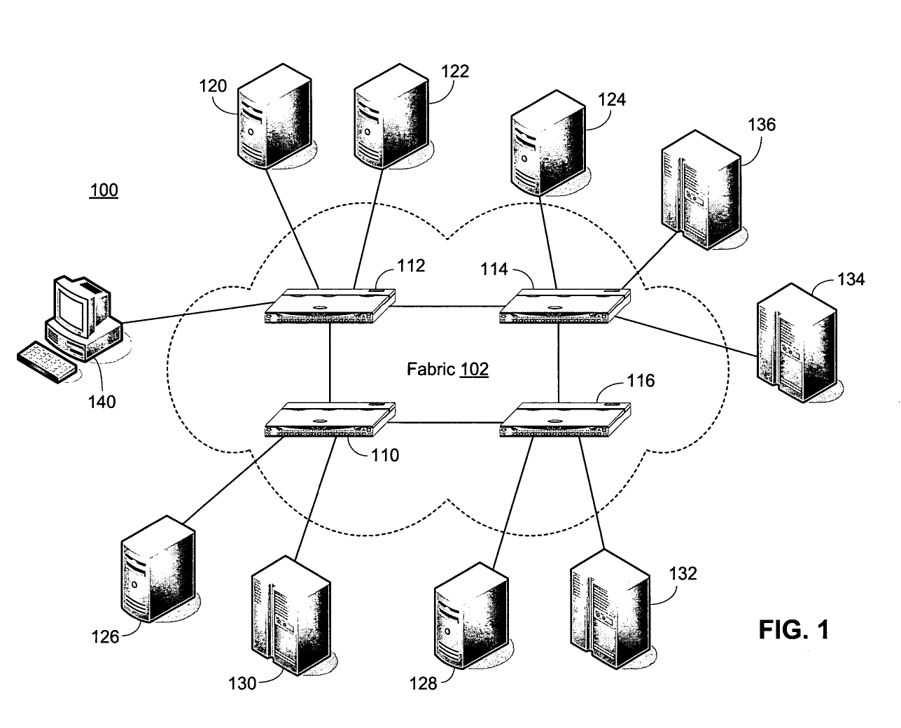

Referring now to FIG. 1, a storage area network (SAN) 100 generally illustrating a conventional configuration is shown. A fabric 102 is the heart of the SAN 100. The fabric 102 is formed of a series of switches 110, 112, 114, and 116, preferably Fibre Channel switches according to the Fibre Channel specifications. The switches 110-116 are interconnected to provide a mesh, allowing any nodes to communicate with any other node. Various nodes and devices can be connected to the fabric 102. For example, a host 126 and a storage device 130 are connected to switch 110. That way the host 126 and storage device 130 can communicate through the switch 110 to other devices. A host 128 and a storage device 132, preferably a unit containing disks, are connected to switch 116. A user interface 140, such as a workstation, is connected to switch 112, as are additional hosts 120 and 122. A host 124 and storage devices 134 and 136 are shown as being connected to switch 114. It is understood that this is a very simplified view of a SAN 100 with representative storage devices and hosts connected to the fabric 102. It is understood that quite often significantly more devices and switches are used to develop the full SAN 100.

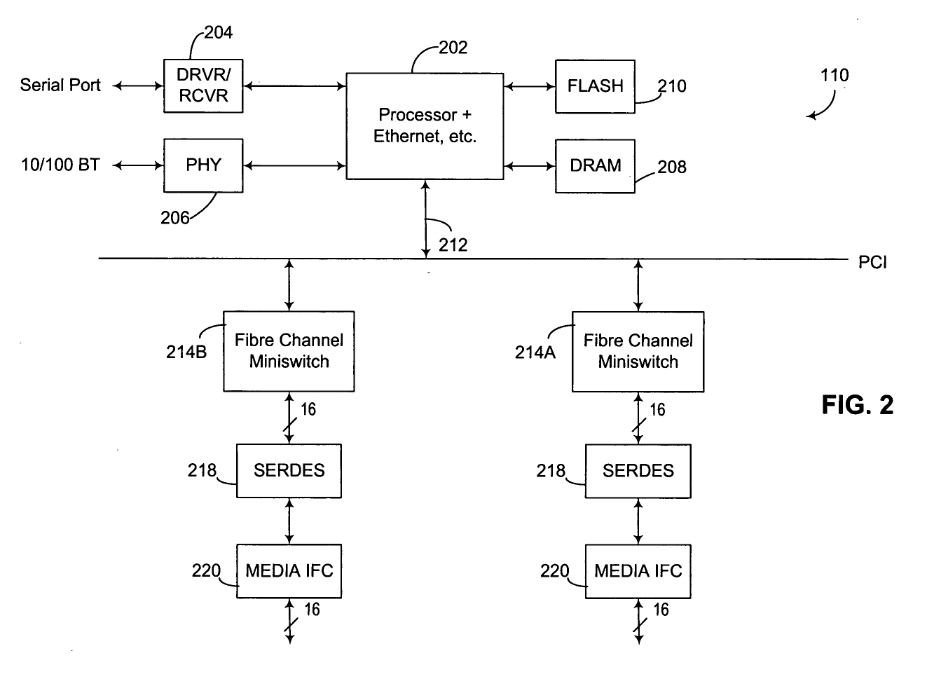

FIG. 2 illustrates a block diagram of a switch 110 according to the preferred embodiment. In switch 110 a processor unit 202 that includes a high performance CPU, preferably a PowerPC, and various other peripheral devices including an Ethernet module, is present. Receiver/driver circuitry 204 for a serial port is connected to the processor unit 202, as is a PHY 206 used for an Ethernet connection. A flash memory 210 is connected to the processor 202 to provide permanent memory for the operating system and other routines of the switch 110, with DRAM 208 also connected to the processor 202 to provide the main memory utilized in the switch 110. A PCI bus 212 is provided by the processor 202 and to it are connected two Fabric Channel miniswitches 214A and 214B. The Fibre Channel miniswitches 214A and 214B are preferably developed as shown in U.S. patent application Ser. No. 10/123,996, entitled, “Fibre Channel Zoning By Device Name In Hardware,” by Ding-Long Wu, David C. Banks, and Jieming Zhu, filed on Apr. 17, 2002 which is hereby incorporated by reference. The miniswitches 214A and 214B thus effectively are 16 port switches. The ports of the miniswitches 214A and 214B are connected to a series of serializers 218, which are then connected to media units 220. It is understood that this is an example configuration and other switches could have the same or a different configuration.

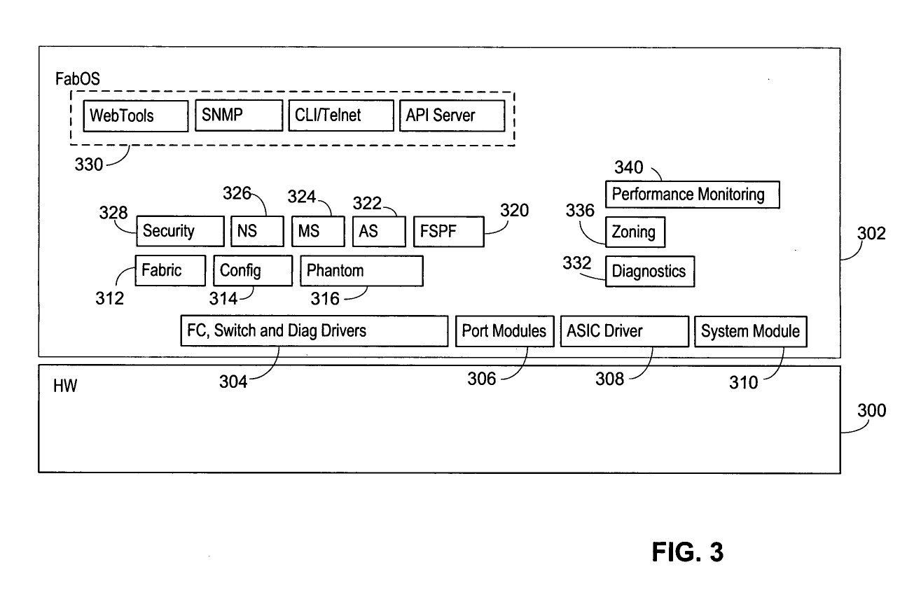

Proceeding then to FIG. 3, a general block diagram of the switch 110 hardware and software is shown. Block 300 indicates the hardware as previously described. Block 302 is the basic software architecture of the switch 110. Generally think of this as the switch 110 fabric operating system and all of the particular modules or drivers that are operating within that embodiment. Modules operating on the operating system 302 are Fibre Channel, switch and diagnostic drivers 304; port modules 306, if appropriate; a driver 308 to work with the Fibre Channel miniswitch ASICs; and a system module 310. Other switch modules include a fabric module 312, a configuration module 314, a phantom module 316 to handle private-public address translations, an FSPF or Fibre Shortest Path First routing module 320, an AS or alias server module 322, an MS or management server module 324, a name server module 326 and a security module 328. Additionally, the normal switch management interface 330 is shown including web server, SNMP, telnet and API modules. Finally, a diagnostics module 332, a zoning module 336 and a performance monitoring module 340 are illustrated. Again, it is understood that this is an example configuration and other switches could have the same or a different configuration.

A multicast frame is a frame with a special D_ID (Destination ID) that indicates a multicast group. All other fields in the frame are standard Fibre Channel fields. A multicast group is a group of ports that have requested to receive all such frames. As opposed to broadcast frames, which are sent to all the active Fx_Ports in the fabric and to the embedded ports contained in the switches and used to transfer frames to the switch CPU (unless explicitly filtered), multicast frames are sent only to the ports that request it. Any port can send a multicast frame without any previous registration or signaling protocol, but only ports that have registered as members of the multicast group will receive it. There are 256 multicast groups. A port can belong to more than one group at the same time. A multicast group may span the whole fabric.

In the preferred embodiment a standard-based service dedicated to multicast group management, called the Alias Server 322, receives requests from an Nx_Port to join a multicast group. These requests can carry more than one port ID, making it possible for an Nx_Port to register other ports to the same group as well. The Alias Server 322 is a distributed service. Once it receives the request, it informs the Alias Servers on all the other switches in the fabric about the new group membership. Each Alias Server, in turn, informs the local routing module 320, which sets up the multicast routing tables on the E_Ports. The FSPF or routing module 320 builds a multicast path as part of its routing path calculation. This path is a tree, rooted on the switch with the smallest Domain ID, that spans the whole fabric. The multicast tree is usually the same for all the multicast groups, and is also usually identical to the broadcast tree but they can be different if optimization is desired.

For the particular application of multicast according to the present invention, the fabric 102 needs to reserve a multicast group. This is a well known group, that is preferably hard coded, to avoid the additional overhead of a negotiation protocol. This choice is preferably backward compatible with installed switches, given that there is no use of multicast in many of the fabrics deployed today. Multicast group 0 is preferably chosen for this purpose, which corresponds to the multicast address 0xfffb00.

This multicast group is used for all the multicast-based traffic in support of all Fabric Services: Zoning, Name Server, RSCNs, etc., and including services that may be defined in the future. There is no need to use different multicast groups for different services, because the demultiplexing of incoming frames remains unchanged.

Because multicast may be used very early on during a switch or a fabric boot, it is preferable to not rely on the Alias Server 322 to set up this multicast group, since it is commonly not among the first services to be started. In addition, there is no need to add any other port in a switch to multicast group 0, besides the embedded port of each switch. Therefore, the functionality of the Alias Server 332 is not needed in the preferred embodiment for this multicast group. Therefore, in the preferred embodiment, multicast group 0 is removed completely from control by the Alias Server 322, in order to prevent user ports from accidentally joining it and receiving Fabric Services traffic. Instead, in the preferred embodiment, the embedded port of a switch joins multicast group 0 automatically during the multicast initialization, right after it joins the broadcast group as part of its normal initialization process. This sets up the correct routing table entries as well. The Alias Server is preferably modified so that it does not operate on multicast group 0.

Once the embedded port is added to multicast group 0, the routing tables will be programmed correctly as new E_Ports come online.

All frames that are transmitted to every switch in the fabric use multicast transmission in the preferred embodiments. This includes zone updates, RSCNs, etc. For non-secure fabrics, this may not include initial zone database exchanges, because those occur only between two adjacent switches (and, if necessary, are subsequently flooded to the rest of the fabric one hop at the time), not from one switch to all the others. However, for secure fabrics, zone exchanges are directly transmitted to all switches in the fabric from one switch instead. In the preferred embodiment, this direct transmission in secure fabrics is replaced by a multicast transmission.

The only change required to transmit a multicast frame is to replace the D_ID of the target switch with the multicast D_ID ‘0xfffb00.’ One single transmission replaces N transmissions to the N switches in the fabric.

Note that some switches may have more than one ISL that is part of multicast group 0, and a multicast frame must be transmitted on all of them to insure that it will reach all switches in the fabric. However, if the frame is generated by the embedded port, the high level software needs to issue only one transmit command. The ASIC driver 308 retrieves from the routing module 320 a bit map of all the ports that it needs to transmit the frame on, sets the appropriate bits in a register, and instructs the ASICs 214A, 214B to transmit the frame. The operations required for the actual transmissions are all handled by the ASIC driver 308 and the ASICs 214A, 214B.

In general and in certain embodiments, if a multicast frame is not locally generated, that is if it is coming in from one of the E_Ports, the ASICs 214A, 214B should automatically transmit it out of all the ports that are members of that multicast group, both E_Ports and F_Ports. In this case according to the present invention, there would be no F_Ports, so the frame should be forwarded just to the embedded port (as a member of multicast group 0) and potentially to some E_Ports. In certain embodiments the frame may just be passed to the embedded port. In those embodiments the embedded port needs to recognize the frame is a multicast frame to group 0 and then apply it internally and transmit it out on all the E_Ports that are part of the multicast tree (except the port from which it was received), in exactly the same way as if the frame was generated by the embedded port.

In certain embodiments this transmission to the E_Ports that are members of multicast group 0 is accomplished with a single software command. To minimize the processing time, it is preferable that this forwarding is performed in the kernel or similar low level. In those cases the kernel driver 304 checks the frame's D_ID. If it is the multicast address of group 0, the driver 304 transmits the frame to all the E_Ports that are members of multicast group 0, and sends it up the stack for further processing.

In certain embodiments, a multicast frame addressed to multicast group 0 would be sent to the switch CPU. The fact that the switch CPU has to forward it to one or more E_Ports should use a small number of switch CPU cycles, as it is preferably done in the kernel. However, this may add a significant amount of delay to the delivery of the frame, especially to switches that are many hops away (along the multicast tree) from the frame's source. These delays should be in the order of a few tens on milliseconds/hop. This increased delay may require some adjustment to the retransmission time-outs.

Reliable multicast is easy to do if all the recipients of the data are known beforehand. In the fabric case, the recipients are the embedded ports of all the switches in the fabric, which every switch knows from the FSPF topology database. To implement a reliable multicast protocol, the sender maintains a table that keeps track, for all the outstanding frames, of all the ACKs that have been received. After receiving each ACK, the sender checks the ACK table. If all the ACKs have been received, the operation has completed and the buffer is freed up. If, after a timeout, some of the ACKs are missing, the switch retransmits the frame to all the switches that have not received the frame. In one embodiment these retransmissions are individual, unicast transmissions, one for each of the switches that has not ACKed the frame. In another embodiment, if there is more than one missing ACK, a multicast transmission to the smaller group of non-responding switches can be done. After that any non-repsonsive switches would receive unicast transmissions.

If the switch receives a RJT for the multicast frame, and the reject reason requires a retransmission, the switch immediately retransmits the frame as unicast to the sender of the RJT. This is done to insure efficiency when interoperating with switches that do not support multicast-based Fabric Services.

The ACK table may be as simple as a bit map and a counter. If a bit map is used to indicate all the switches in the fabric as well, then a simple comparison of the two bit maps can determine which of the switches have not ACKed the frame, when the counter indicates that there are some frames outstanding at the timeout.

It is relevant to specify how “all the switches in the fabric” are identified. These are all the switches that are reachable from a given switch. The data structure used to make this determination is FSPF's topology database. This database is a collection of Link State Records (LSRs), each one representing a switch in the fabric. The presence of an LSR representing switch B in switch A's database does not automatically mean that switch B is reachable from switch A. During switch A's shortest path calculation, a bit is set in a field associated with switch B's LSR, when switch B is added to the shortest path tree. Switch B is reachable as long as this bit is set. If a switch is not reachable, there is no point in waiting for an ACK from it, or in sending a unicast frame to it.

Although the lack of hardware forwarding of a multicast frame does not impact the overall performance excessively in such embodiments, it may still add some delay to a frame. Each switch must complete the frame reception and then activate the software to initiate the forwarding. The amount of additional latency can be significant, especially if a frame has to traverse many branches of the multicast tree. Since there is a single time-out for all the ACKs to a multicast frame, such time-out must be set high enough to allow the frame to reach all switches, and all the unicast ACKs to come back.

In certain embodiments the Name Server implements a replicated database using a push/pull model as more fully described in U.S. Ser. No. 10/208,376, entitled “Fibre Channel Switch Having a Push/Pull Method for Caching Remote Switch Information,” by Richard L. Hammons, Raymond C. Tsai and Lalit D. Pathak filed Jul. 30, 2002, which is hereby incorporated by reference.

Prior to that design, the Name Server cached some of the data from remote switches, but not all of it. When a request came in, if the Name Server did not have the data in its local database, it queried all the other switches, one at the time, until it received a response, or it timed out. It then cached the response and relayed the data to the requester. The queries to remote switches were done sequentially, waiting for a response before querying the next switch. This approach worked for very small fabrics, but did not scale so the push/pull scheme was developed. The use of multicast according to the present invention allows a return to a similar approach, with or without true caching. The local name server can query all the switches at once with a single multicast request, instead of individually. The time to get a response would be approximately the same as if it was querying one switch only, except for the few tens of ms/hop of forwarding time without hardware-assisted multicast.

This multicast method requires a smaller amount of memory for the Name Server than the push/pull method. In certain embodiments the multicast response to any query may be fast enough to eliminate caching altogether. Then every switch would keep its local information only, and send a multicast query every time the requested information is not local.

Different embodiments in different switch models would interoperate. For example, a low-end switch could use no caching and query the other switches every time to save memory, whereas a high-end switch with a lot of memory in the same fabric could use some caching for a lower response time.

In other embodiments, the push/pull Name Server embodiments could check memory usage, and use multicast queries if memory is exhausted. When that happens, and the Name Server receives a query for an item that is not in its local database, the Name Server sends a multicast query to the other switches and responds to the requester appropriately, even if it is not able to cache the new data.

The zoning database exchange protocol is very different for secure and non-secure fabrics, as stated above. In secure fabrics, the database is sent directly from one of a small set of trusted servers to all the other switches in the fabric. This can easily take advantage of multicast transmission, according to the present invention. In non-secure fabrics, when an E_Port comes up there is a database exchange between the two switches, which, in case the two databases are different, can lead to a merge or to a segmentation. In certain embodiments the secure fabric model could be used for non-secure fabrics, and then both could take advantage of the multicast protocol. Preferably there would be a command to turn this behavior on and off, since the multicast solution for non-secure fabrics may not be interoperable with other vendors' switches nor with prior switches.

This protocol is backward compatible with the existing installed base. In a mixed fabric of new and old switches, a new switch preferably uses multicast transmission, as a first attempt. If after a timeout some of the switches have not acknowledged the frame, the retransmissions are unicast as described above. Then the old switches may not be able to handle the multicast traffic. In such a case, it may be desireable to design the fabric so that all the new switches are on the same sub-tree of the multicast tree, in order to maximize the number of switches that can take advantage of multicast transmission.

Waiting for a timeout in a mixed fabric before making the first attempt to deliver a frame can add extra delay to the fabric operations. If this is a concern, one embodiment could “mark” the new switches, so that when a switch transmits a multicast frame, it can immediately send the same frame as unicast to all the unmarked switches.

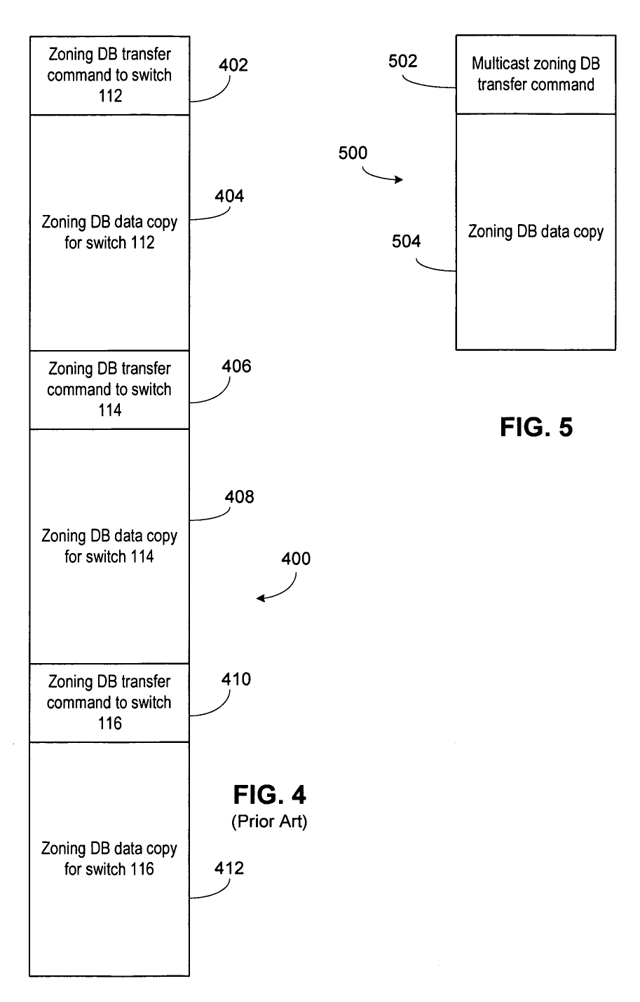

FIG. 4 provides an illustration of buffer 400 memory space according to the prior art. In this example it is assuming that switch 110 is performing a zoning database transfer, one of the commands which is done to all other switches but is not a full flood or multicast to the entire SAN. According to the prior art in this case three separate commands would have been issued. The first command 402 would be a command to transfer the database to switch 112 with the command being followed by the actual zoning database data 404. Following this in the buffer, would be the command to transfer the data to switch 114 followed by the data 408. This would be then followed by the third repetition of the command 410 to transfer the data to switch 116 followed by the data 412. As can be seen, even in this example of a simple four switch network a large amount of buffer space is taken up in performing three individual transfers.

In a variation, only one copy of the data would be present and would be referenced by each command. While this reduces buffer space usage, the presence of multiple commands still uses more buffer space then is desirable.

Referring then to FIG. 5, the buffer 500 according to the present invention is shown. The buffer contains a multicast zoning database transfer command 502 according to the present invention and a copy of the zoning database information 504. As can be seen, there is only a single command and a single set of the database data rather than even the three sets shown in FIG. 4. It will be clearly appreciated that should this be a much larger network with significantly more switches, even greater buffer space would have been saved.

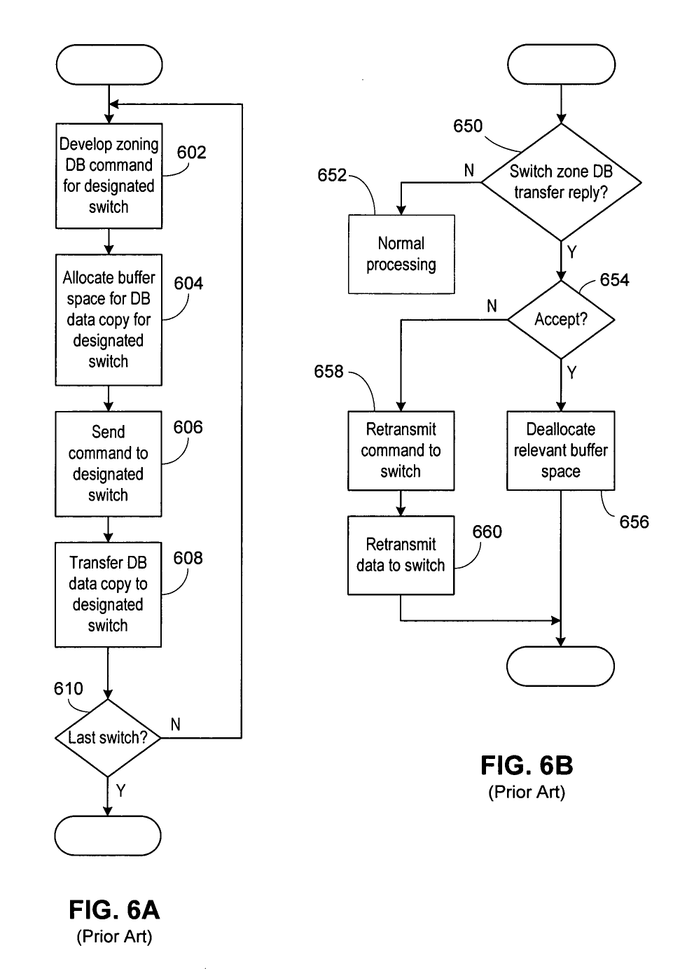

FIGS. 6A and 6B are flow charts of a transmitting switch performing a database copy of the zoning information as shown with the buffer of FIG. 4. In FIG. 6A in step 602, the transmitting switch develops the zoning database command for the first designated switch. Then in step 604 buffer space is allocated for the copy of the data to be passed to that designated switch and filled with data. In step 606 the command to do the zoning database transfer is transmitted and then in step 608 the actual data itself is copied to the designated switch. In step 610 a determination is made as to whether the last switch has had its information transmitted to it. If not, control returns to step 602 where the whole cycle is repeated again for the next switch. If it was the last switch, the operation is complete after step 610.

The transmitting switch in step 650 also determines if a received reply is in response to the zoning database transfer. If not, control proceeds to step 652 where normal processing occurs. If this is a reply from a receiving switch to the transmitting switch, control proceeds to step 654 to determine if the transfer was accepted. If so, control proceeds to step 656 where the relevant buffer space is de-allocated. If it was not accepted, control proceeds to step 658 where the command is retransmitted and to step 660 where the data is retransmitted to the switch that rejected or did not complete the transfer operation.

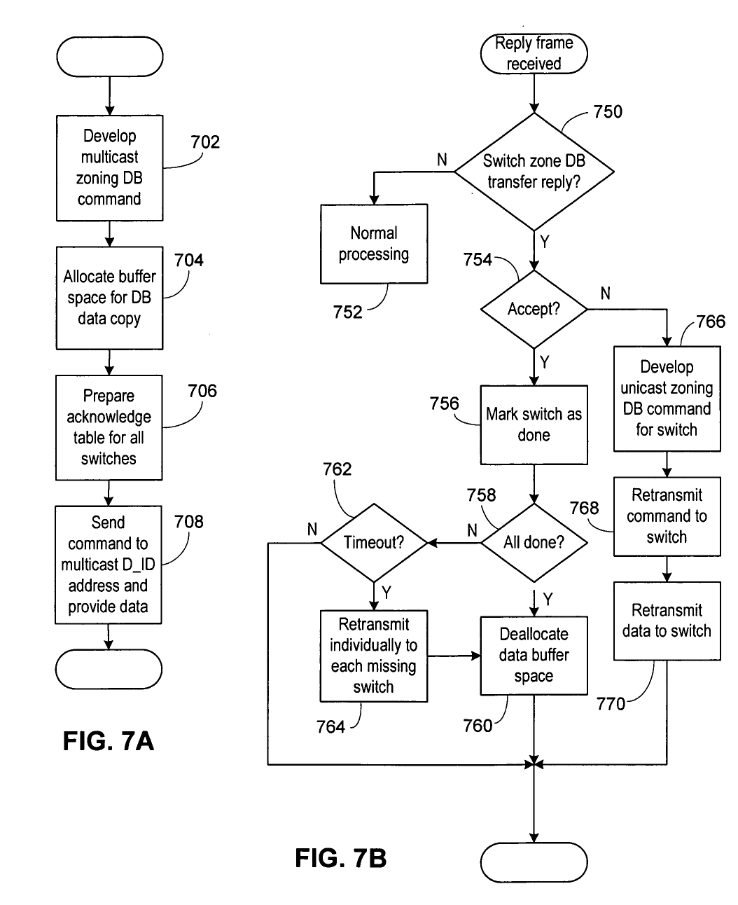

Operations according to the present invention are shown in FIGS. 7A and 7B. In FIG. 7A in step 702 the transmitting switch develops the multicast zoning database command as described above. Effectively this is a zoning database transfer directed to the multicast address for group 0. Control then proceeds to step 704 where the buffer space for the copy of the data of the zoning database is allocated and the data is loaded. Then in step 706 an acknowledge table is prepared for all switches so that it can be determined which switches have and have not replied and successfully received the zoning database. In step 708 the command is transmitted to the multicast D_ID address with the attached data. Then as described above, normal operations of the switch would transmit the multicast packet down the multicast tree to each of the relevant switches.

Referring then to FIG. 7B, the transmitting switch receives a frame, determines if it is a reply and determines in step 750 if this was a switch zoning database transfer reply, i.e., to the multicast command provided in step 708. If not, control proceeds to step 752 to continue normal processing. In step 754 if it was a reply, it is determined if the reply was an accept, i.e., the transfer was completed correctly. If so, control passes to step 756 where the switch is marked as done in the acknowledge table. After marking the switch as done, control proceeds to step 758 to determine if all switches have been marked as done. If so, in step 760 the buffer space is de-allocated. If they are not all done, control proceeds to step 762 to determine if a timeout has occurred. It is assumed that the multicast operation will complete in some given timeframe. If all acknowledges have not been received in that time it means there are errors. Control then proceeds to step 764 and the zoning database is transmitted individually as shown in the prior art FIG. 6A to each switch which has not acknowledged. The data buffer space for the multicast command is then deallocated in step 760. If there is no timeout then control exits this process.

If the reply was not an accept in step 754, control proceeds to step 766 where a unicast zoning database command is developed and then transmitted in step 768 along with the data in step 770. Thus if a rejection is received, immediately a unicast transmission is developed. Step 764 is primarily used where a timeout will have occurred should a switch not reply at all.

While illustrative embodiments of the invention have been illustrated and described, it will be appreciated that various changes can be made therein without departing from the spirit and scope of the invention.

What is claimed is:

1. A method for transmitting a fabric services command in a fabric, the fabric formed by a plurality of switches and the fabric services command directed to the switches, the method comprising:
forming a multicast group of the switches to receive the fabric services command;
preparing a fabric services command and addressing it to the multicast group; and
transmitting the fabric services command addressed to the multicast group.

2. The method of claim 1, wherein the fabric is a Fibre Channel fabric.

3. The method of claim 1, wherein the multicast group is group 0.

4. The method of claim 1, wherein the step of preparing a fabric services command includes:
providing buffer space to hold the fabric services command;
providing buffer space to hold data associated with the fabric services command;
placing the fabric services command in the buffer space; and
placing the associated data in the buffer space.

5. The method of claim 1, further comprising:
determining which switches have not successfully received the fabric services command; and
transmitting the fabric services command as a unicast transmission to each of the switches which have not successfully received the fabric services command.

6. The method of claim 5, wherein the step of determining includes:
preparing a table having entries representing each of the switches;
placing a received value in a table entry representing a switch if an acknowledgment is received from that switch; and
reviewing the table for entries not containing the received value.

7. The method of claim 5, wherein the step of determining is performed after a timeout.

8. The method of claim 1, further comprising:
transmitting the fabric services command as a unicast transmission to a switch which rejects the multicast transmission.

9. The method of claim 1, wherein the fabric service command is at least one of:
a zoning database transfer;
a registered state change notification;
a distributed registered link incident report; and
a name server update.

10. A switch for transmitting a fabric services command in a fabric, the fabric formed by a plurality of switches and the fabric services command directed to the switches, the switch comprising:
a microprocessor;
memory connected to said microprocessor to hold programs and data; and
a fabric device coupled to said microprocessor and for coupling to other switches,
wherein the memory contains a program to cause said microprocessor to:
form a multicast group of the switches to receive a fabric services command;
prepare a fabric services command and address it to said multicast group; and
transmit said fabric services command addressed to said multicast group.

11. The switch of claim 10, wherein the fabric is a Fibre Channel fabric.

12. The switch of claim 10, wherein the multicast group is group 0.

13. The switch of claim 10, wherein preparing a fabric services command includes:
providing buffer space to hold the fabric services command;
providing buffer space to hold data associated with the fabric services command;
placing the fabric services command in the buffer space; and
placing the associated data in the buffer space.

14. The switch of claim 10, wherein the program further causes said microprocessor to:
determine which switches have not successfully received said fabric services command; and
transmit said fabric services command as a unicast transmission to each of the switches which have not successfully received said fabric services command.

15. The switch of claim 14, wherein determining includes:
preparing a table having entries representing each of the switches;
placing a received value in a table entry representing a switch if an acknowledgment is received from that switch; and
reviewing said table for entries not containing said received value.

16. The switch of claim 14, wherein determining is performed after a timeout.

17. The switch of claim 10, wherein the program further causes said microprocessor to:
transmit said fabric services command as a unicast transmission to a switch which rejects the multicast transmission.

18. The switch of claim 10, wherein the fabric service command is at least one of:
a zoning database transfer;
a registered state change notification;
a distributed registered link incident report; and
a name server update.

19. A communication fabric comprising:
a plurality of switches; and
links interconnecting various of said plurality of switches to allow communication between the switches in said plurality of switches,
wherein at least one switch of said plurality of switches transmits a fabric services command, the fabric services command directed to the switches in said plurality of switches, and wherein said at least one switch includes:
a microprocessor;
memory connected to said microprocessor to hold programs and data; and
a fabric device coupled to said microprocessor and connected to at least two links,
wherein the memory contains a program to cause said microprocessor to:
form a multicast group of the switches to receive a fabric services command;
prepare a fabric services command and address it to said multicast group; and
transmit said fabric services command addressed to said multicast group.

20. The fabric of claim 19, wherein the fabric is a Fibre Channel fabric.

21. The fabric of claim 19, wherein the multicast group is group 0.

22. The fabric of claim 19, wherein preparing a fabric services command includes:
providing buffer space to hold the fabric services command;
providing buffer space to hold data associated with the fabric services command;
placing the fabric services command in the buffer space; and
placing the associated data in the buffer space.

23. The fabric of claim 19, wherein the program further causes said microprocessor to:
determine which switches have not successfully received said fabric services command; and
transmit said fabric services command as a unicast transmission to each of the switches which have not successfully received said fabric services command.

24. The fabric of claim 23, wherein determining includes:
preparing a table having entries representing each of the switches;
placing a received value in a table entry representing a switch if an acknowledgment is received from that switch; and
reviewing said table for entries not containing said received value.

25. The fabric of claim 23, wherein determining is performed after a timeout.

26. The fabric of claim 19, wherein the program further causes said microprocessor to:
transmit said fabric services command as a unicast transmission to a switch which rejects the multicast transmission.

27. The fabric of claim 19, wherein the fabric service command is at least one of:
a zoning database transfer;
a registered state change notification;
a distributed registered link incident report; and
a name server update.

28. A computer readable medium containing software for transmitting a fabric services command in a fabric, the fabric formed by a plurality of switches and the fabric services command directed to the switches, the software for instructing a microprocessor to perform the steps of:
forming a multicast group of the switches to receive a fabric services command;
preparing a fabric services command and address it to said multicast group; and
transmitting said fabric services command addressed to said multicast group.

29. The medium of claim 28, wherein the fabric is a Fibre Channel fabric.

30. The medium of claim 28, wherein the multicast group is group 0.

31. The medium of claim 28, wherein the step of preparing a fabric services command includes:
providing buffer space to hold the fabric services command;
providing buffer space to hold data associated with the fabric services command;
placing the fabric services command in the buffer space; and
placing the associated data in the buffer space.

32. The medium of claim 28, wherein the software further causes said microprocessor to:
determine which switches have not successfully received said fabric services command; and
transmit said fabric services command as a unicast transmission to each of the switches which have not successfully received said fabric services command.

33. The medium of claim 32, wherein the step of determining includes:
preparing a table having entries representing each of the switches;
placing a received value in a table entry representing a switch if an acknowledgment is received from that switch; and
reviewing said table for entries not containing said received value.

34. The medium of claim 32, wherein the step of determining is performed after a timeout.

35. The medium of claim 28, wherein the software further causes said microprocessor to:
transmit said fabric services command as a unicast transmission to a switch which rejects the multicast transmission.

36. The medium of claim 28, wherein the fabric service command is at least one of:
a zoning database transfer;
a registered state change notification;
a distributed registered link incident report; and
a name server update.

37. A communication network comprising:
a host;
a storage device;
a plurality of switches;
links interconnecting various of said plurality of switches to allow communication between the switches in said plurality of switches; and
links connecting said host and said storage device to separate switches of said plurality of switches,
wherein at least one switch of said plurality of switches transmits a fabric services command, the fabric services command directed to the switches in said plurality of switches, and wherein said at least one switch includes:
a microprocessor;
memory connected to said microprocessor to hold programs and data; and
a fabric device coupled to said microprocessor and connected to at least two links,
wherein the memory contains a program to cause said microprocessor to:
form a multicast group of the switches to receive a fabric services command;
prepare a fabric services command and address it to said multicast group; and
transmit said fabric services command addressed to said multicast group.

38. The fabric of claim 37, wherein the fabric is a Fibre Channel fabric.

39. The fabric of claim 37, wherein the multicast group is group 0.

40. The fabric of claim 37, wherein preparing a fabric services command includes:
providing buffer space to hold the fabric services command;
providing buffer space to hold data associated with the fabric services command;
placing the fabric services command in the buffer space; and
placing the associated data in the buffer space.

41. The fabric of claim 37, wherein the program further causes said microprocessor to:
determine which switches have not successfully received said fabric services command; and
transmit said fabric services command as a unicast transmission to each of the switches which have not successfully received said fabric services command.

42. The fabric of claim 41, wherein determining includes:
preparing a table having entries representing each of the switches;
placing a received value in a table entry representing a switch if an acknowledgment is received from that switch; and
reviewing said table for entries not containing said received value.

43. The fabric of claim 41, wherein determining is performed after a timeout.

44. The fabric of claim 37, wherein the program further causes said microprocessor to:
transmit said fabric services command as a unicast transmission to a switch which rejects the multicast transmission.

45. The fabric of claim 37, wherein the fabric service command is at least one of:
a zoning database transfer;
a registered state change notification;
a distributed registered link incident report; and
a name server update.
